(19) United States
(12) Patent Application Publication
(10) Pub. No.: US 2006/0046236 A1
(43) Pub. Date: Mar. 2, 2006

(54) Method for testing the vibration-resisting strength of building models

(75) Inventors: Sheng-Fu Peng, Tainan City (TW); Wen-Tsung Chang, Fengshan City (TW)

Correspondence Address: Sheng-Fu PENG, P.O. Box 90, Tainan City, 704, TW

(73) Assignee: NATIONAL KAOHSIUNG UNIVERSITY OF APPLIED SCIENCES

(21) Appl. No.: 10/929,391

(22) Filed: Aug. 31, 2004

(30) Foreign Application Priority Data
Aug. 26, 2004 (TW) 093125454

(51) Int. Cl. G09B 23/10

(52) U.S. Cl. 434/322; 434/302

(57) ABSTRACT

A method for testing the vibration-resisting strength of building models includes six steps. Step 1: Students to participate in model making are divided into teams. Step 2: Each team begins to make a building model according to the regulations. Step 3: The building model is weighed with a scale and then assembled on an earthquake-simulating vibration table to be tested. Step 4: The team explains the design concept of the building model before the building model is tested. Step 5: The building model begins to be tested. Step 6: Register the acceleration scores of the building model after testing. Making and testing of building models can elevate students' interest in learning the vibration resistance principles of buildings and stir up students' creativity and thinking ability in methods of vibration resistance and reinforcement of buildings.

### BACKGROUND OF THE INVENTION

1. Field of the Invention

This invention relates to a method for testing the vibration-resisting strength of building models, particularly to one including six steps. Step 1: Students to participate in model making are divided into teams; Step 2: Each team makes a building model with Ivory board within six and a half hours and the building model made by the team must be able to bear a weight of 1.2 kilograms; Step 3: After the building model is made by the team, it is weighed with a scale and then assembled on an earthquake-simulating vibration table; Step 4: Before the building models are tested, each team has 30 seconds to explain the design concept of the building model; Step 5: The building models begin to be tested; Step 6; Register the acceleration marks of the building models after they are tested. The earthquake simulating vibration table can produce simulated earthquakes containing various kinds of frequency of earthquakes. The test begins with a minimum seismic strength with 490 gal of acceleration and then the seismic strength increases by degrees until it reaches to 1160 gal to let the earthquake-simulating vibration table produce a maximum seismic strength and make all the building models collapsed, and after finishing the test, the acceleration marks are registered. Substantially, making and testing of building models can elevate students' interest in learning the vibration-resisting principles of buildings and stir up their creativity and thinking ability in methods of the vibration resistance and reinforcement of buildings, able to be expanded to schools to be a course of vibration resistance education.

2. Description of the Prior Art

In order to encourage students to take part in scientific competition and stir up their creativity, the National Seismic Engineering Research Center and the England Cultural Association will sponsor an “interscholastic competition in seismic engineering model making” in September each year for senior high school students, college students and graduate students to participate in. To know the regulations of such a competition, students can surf on the net, searching for the net address of the National Seismic Engineering Research Center “http://www.Ncree. Gov.tw/” and click “vibration preventive education” and then click “vibration-resistance competition”. In a national interscholastic competition in seismic engineering model making, materials for making a building model include wooden bars, A4 photocopy paper, cotton cords, PVC hot-melt glue, a hot-melting gun and a square wooden board, but cost of these materials is so high that students can hardly afford it to make and test building models by themselves.

### SUMMARY OF THE INVENTION

The objective of the invention is to offer a method for testing the vibration-resisting strength of building models so as to elevate students' interest in learning the vibration resistance principles of buildings and stir up their creativity and thinking ability in methods of the vibration resistance and reinforcement of buildings, able to be expanded to schools to be a course of vibration resistance education.

In this invention, students to take part in model making are divided into teams to make building models with Ivory board within six and a half hours and each building model must be able to bear a weight of 1.2 kilograms. After the building model is made, it is weighed with a scale and then assembled on an earthquake-simulating vibration table to be tested. Before testing of the building model, each team has 30 seconds to explain the design concept of the building model. The earthquake-simulating vibration table can produce simulated earthquakes including various kinds of frequency of earthquakes. The test of the building models begins with a minimum seismic strength with 490 gal of acceleration and then the seismic strength increases by degrees until it reaches to 1160 gal to let the earthquake-simulating vibration table produce a maximum seismic strength and make all the building models collapsed. After finishing the test, the acceleration marks are registered. In reality, making and testing of building models can elevate students' interest in learning the vibration resistance principles of buildings and stir up their creativity and thinking ability in methods of the vibration resistance and reinforcement of buildings, able to be expanded to schools to be a course of vibration resistance education.

### BRIEF DESCRIPTION OF DRAWINGS

This invention will be better understood by referring to the accompanying drawings, wherein:

FIG. 1 is a block diagram of a test process of building models in the present invention;

FIG. 2 is a perspective view of a paper building model in the present invention;

FIG. 3 is a perspective view of a single floor of the paper building model with specific dimensions in the present invention;

FIG. 4 is an evolved view of a single floor of the paper building model in the present invention;

FIG. 5 is a perspective view of the paper building model with a reinforced structure in the present invention;

FIG. 6 is a perspective view of a finished paper building model in the present invention;

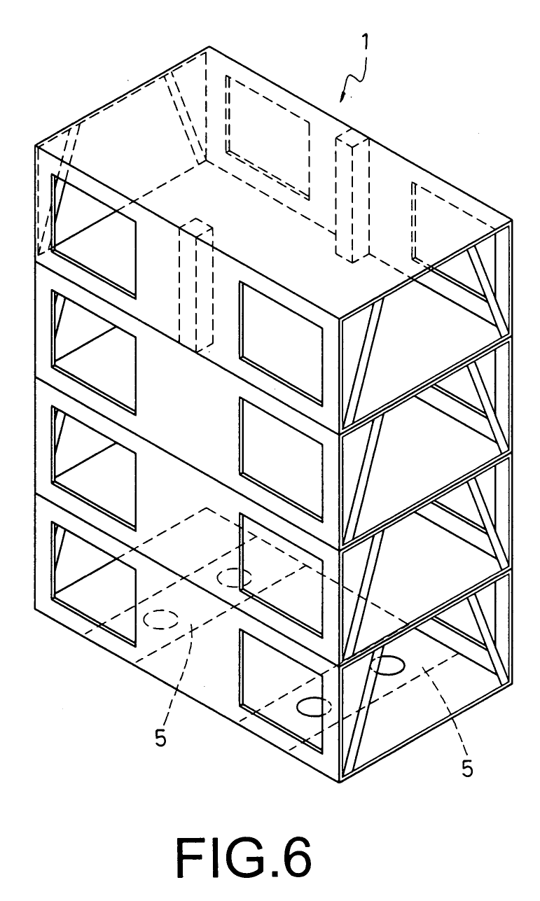

FIG. 7 is a perspective view of the paper building model having a mass block fixed on each floor in the present invention; and,

FIG. 8 is a perspective view of the paper building models assembled on an earthquake-simulating vibration table in the present invention.

### DETAILED DESCRIPTION OF THE PREFERRED EMBODIMENT

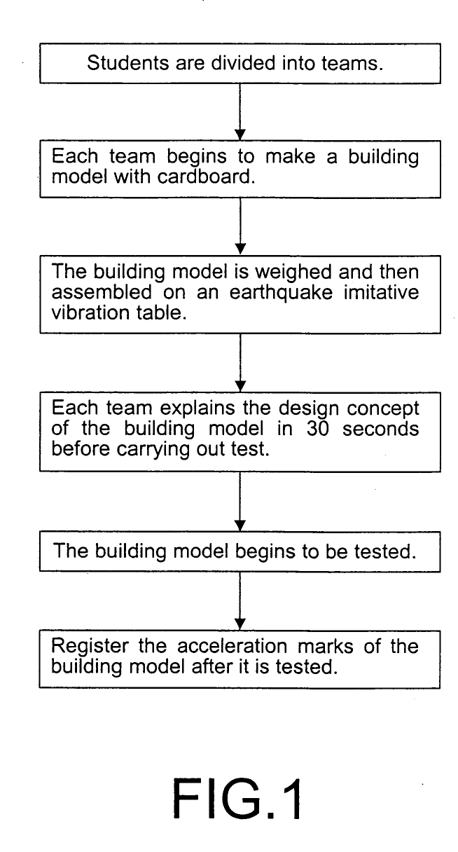

A preferred embodiment of a method for testing the vibration-resisting strength of building models in the present invention, as shown in FIG. 1, includes the following steps.

Step 1: Students to participate in model making are divided into teams.

Step 2: The teams begin to make building models, having to observe the regulations to design paper building models with an excellent vibration-resisting strength by means of limited materials. Each team has to make a building model within six and a half hours and the building model they make must be able to bear a weight of 1.2 kilograms.

Step 3: After the building model is made, it is weighed with a scale and then assembled on an earthquake imitative vibration table to be tested.

Step 4: Each group has 30 seconds to explain the design concept of the building models.

Step 5: The building models begin to be tested.

Step 6: The acceleration scores of the building models are registered after finishing test.

Materials prescribed and regulations for making building models are respectively described as follows.

1. Materials and tools for making the building models:
(1). Specifications and number of materials:
   (a). Four sheets of Ivory board 540ₘₘ×387ₘₘ in size;
   (b). A can of white glue; and,
   (c). Four sheets of magic felt, respectively 7.5_{cm}×2.5_{cm} in size.
(2). Specifications and number of tools:
   (a). A pair of scissors;
   (b). A craftsman's knife (0.9_{cm} in width); and,
   (c). A rule (30_{cm} in length).

Each team participating in the test may provide themselves with notebooks, pencils, calculators and erasers. Each team is allowed to mark design modes on the Ivory board, but non-prescribed materials (including other gluing materials) or tools are completely prohibited from using for making the building model.

2. Regulations in structure and weight:

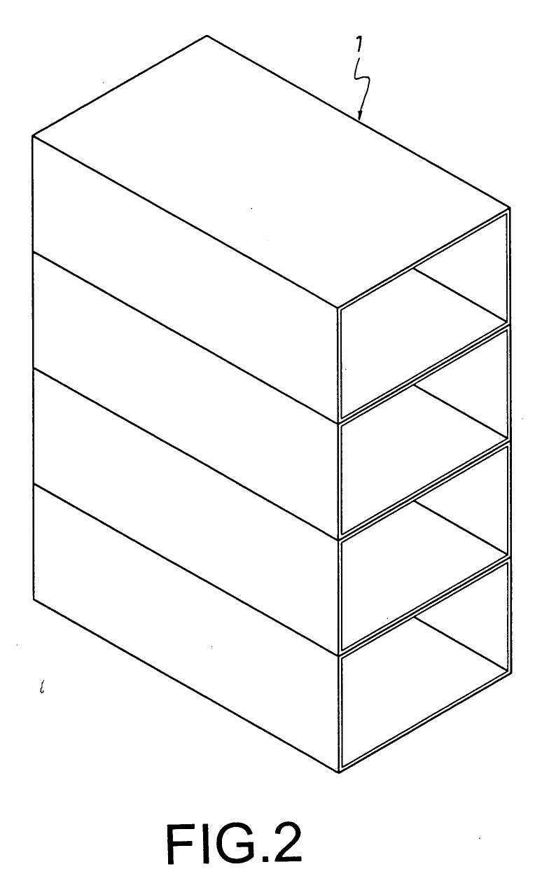

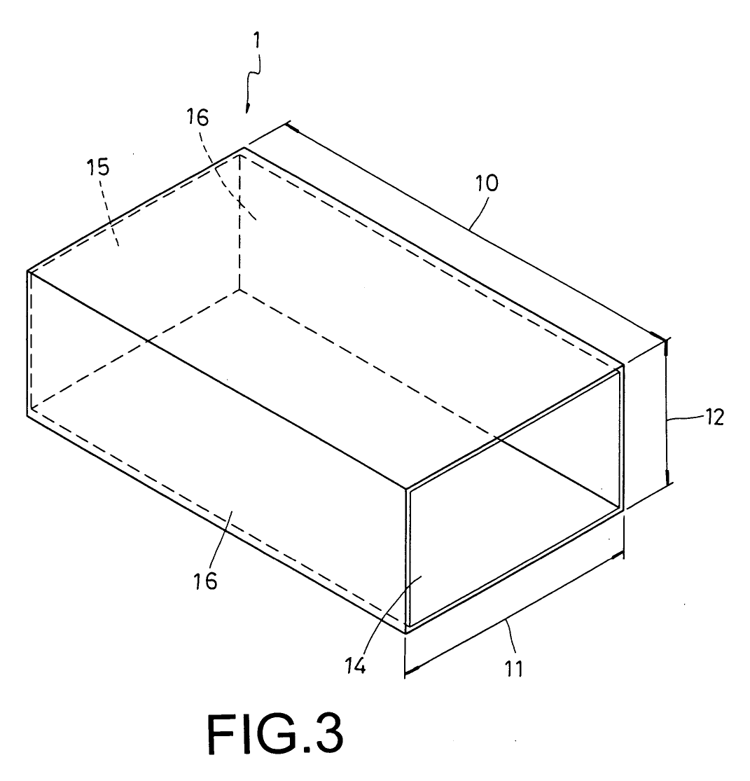

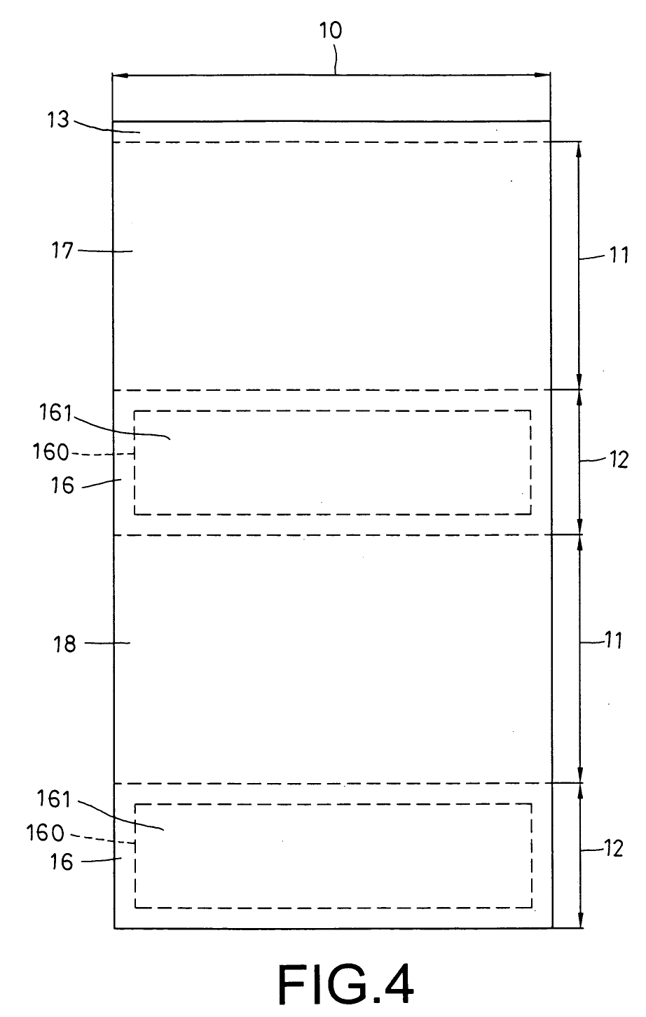

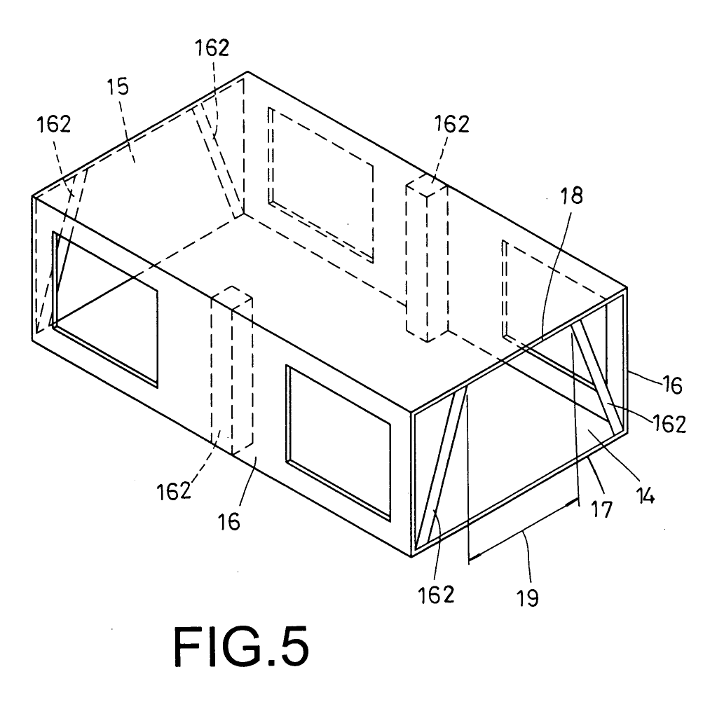

(1). There are at least four floors 1 respectively formed with at least four plane surfaces, as shown in FIG. 2. Each floor is 21_{cm} in length 10, 12_{cm} in width 11 and 7_{cm} in height 12, as shown in FIGS. 3 and 4. The Ivory board has one edge 1_{cm} in width reserved to be a gluing portion 13. Each floor is formed with four sides and, according to the regulation, the front side 14 and the rear side 15 of each floor must be hollowed out, and the left and the right side respectively have an intermediate portion formed with a cut-out portion 160, as shown in FIG. 4, and the materials 161 cut out of the left and the right side are used as material for reinforced structures 162 of the floor 1, as shown in FIG. 5. The distance from the bottom 17 to the ceiling 18 of each floor 1 is at least 7_{cm} in height, and each floor 1 has its central portion reserving a solid net space 5_{cm} in width 19, as shown in FIG. 5. The finished building model has the ground floor formed with two assembling spaces 5 at the locations respectively distant from the front side 14 and the rear side 15 by 3_{cm} to 6_{cm}. These two assembling spaces 5 are only used for assembling the building model on the earthquake-simulating vibration table, not allowed to be used for structure reinforcement or the like.

(2). Regulations in weight:

Each floor of the building model has to be designed in accordance with the regulations. The maximum net weight of each building model is restricted to 124_{g}+5_{g} and overweight will be checked and punished. Punishment for a little overweight is to have the weight of the building model multiplying a penalty coefficient, but if overweight is too much, the building model will be decided to lose qualification for test.

(3). Penalty coefficient: weight of building model×(1+overweight (_{g})/10).

3. Regulations of load:

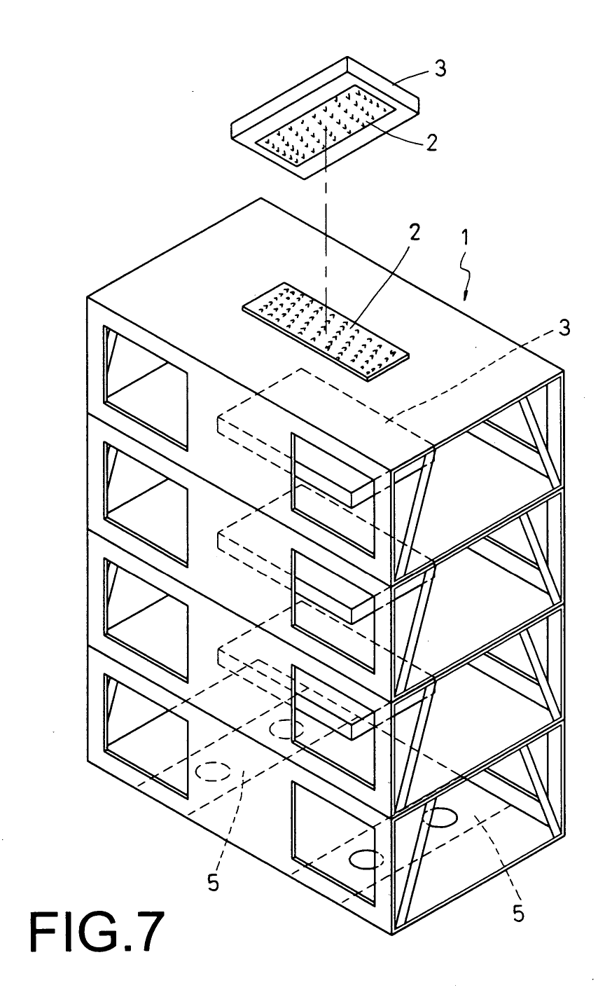

(1). Mode of loading: a mass block 3 is fixed on each floor 1 of the building model by means of a magic felt 2, as shown in FIG. 7.

(2). The mass block 3 is fixed on the mass center of each floor 1.

(3). The mass block 3 is 286_{g} in weight and 8_{cm}×5_{cm} in area.

4. Judgment of vibration resistance test:

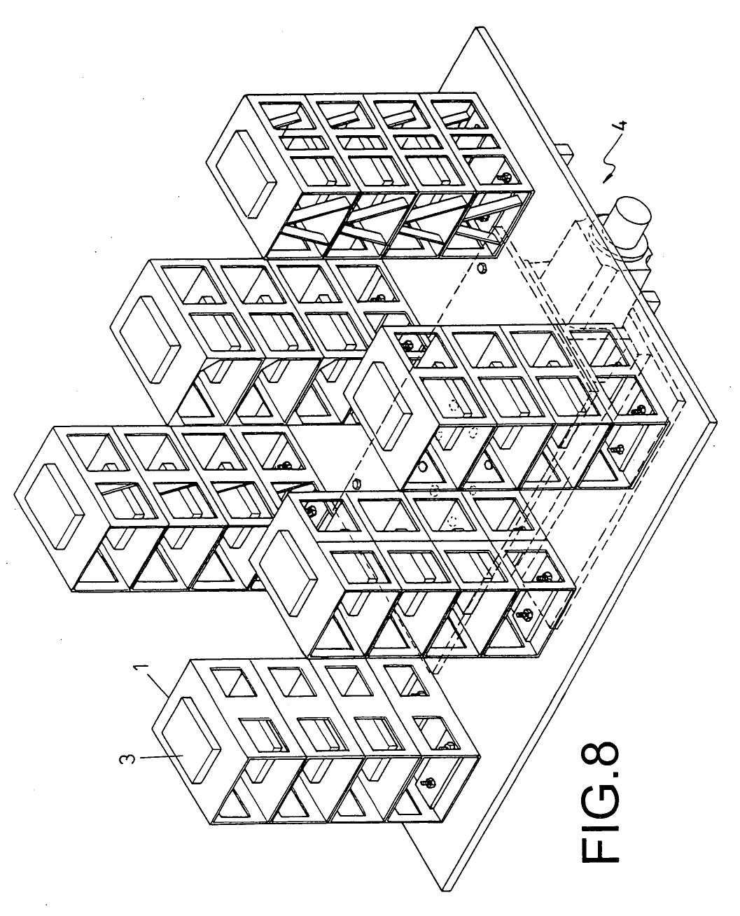

The building model made by each team is assembled on the earthquake-simulating vibration table 4 to be tested, as shown in FIG. 8. The earthquake-simulating vibration table 4 can produce simulated earthquakes including various kinds of frequency of earthquakes. The test begins with a minimum seismic strength with 490 gal of acceleration and then the seismic strength increases by degrees until it reaches to 1160 gal to let the earthquake imitative vibration table 4 produce a maximum seismic strength to make all the building model collapsed.

In the process of vibration-resisting test, if any of the following situations should happen, the building model will lose qualification of being tested.

(1). Unsteadiness or collapse happens to any floor 1 of the building model;

(2). Any mass block 3 moves away from its should-be position;

(3). Any post of the building model moves away from the ground; and,

(4). Other portions of the building model are judged to be damaged.

5. Calculation modes of marks given by the examiners: (load of mass block/net weight of building model) x acceleration of collapse.

Test of energy:

TABLE 1
Extents of acceleration of increasing load to be tested
for 12 times:

| Extents of | Multiplication of given | |
|---|---|---|
| acceleration | scores | Footnote |
| 490 gal | | Not registered in case |
| | | of failing to pass |
| 520 gal | | |
| 630 gal | | |
| 810 gal | | |
| 890 gal | | |
| 980 gal | | |
| 1000 gal | | |
| 1160 gal | | |
| 1160 gal | multiply 1.1 times | second time |
| 1160 gal | multiply 1.2 times | third times |
| 1160 gal | multiply 1.3 times | fourth time |
| 1160 gal | multiply 1.4 times | fifth time |
| 1160 gal | multiply 1.5 times | sixth time |

TABLE 2
Test begins with 810 gal of acceleration and the mass
load increases for 1.5 times if the building model is
not damaged after the test of second time:

| Extents of | Multiplication of given | |
|---|---|---|
| acceleration | mark | Footnote |
| 810 gal | multiply 1.5 times | Beginning of test of |
| | | acceleration for a |
| | | second time |
| 890 gal | multiply 1.5 times | |
| 980 gal | multiply 1.5 times | |
| 1000 gal | multiply 1.5 times | |
| 1160 gal | multiply 1.5 times | |
| 1160 gal | multiply 1.65 times | second time |
| 1160 gal | multiply 1.8 times | third time |
| 1160 gal | multiply 1.95 times | fourth time |
| 1160 gal | multiply 2.1 times | fifth time |
| 1160 gal | multiply 2.25 times | sixth time |

TABLE 3
Test begins with 890 gal of acceleration and the mass
load increases for 1.5 times if the building model is
not damaged after testing for a third time:

| Extents of | Multiplication of given | |
|---|---|---|
| acceleration | mark | Footnote |
| 890 gal | Multiply 2.25 times | Beginning test of |
| | | acceleration for a |
| | | third time |
| 980 gal | Multiply 2.25 times | |
| 1000 gal | Multiply 2.25 times | |
| 1160 gal | Multiply 2.25 times | |
| 1160 gal | Multiply 2.475 times | Second time |
| 1160 gal | Multiply 2.7 times | Third time |
| 1160 gal | Multiply 2.925 times | Fourth time |
| 1160 gal | Multiply 3.15 times | Fifth time |
| 1160 gal | Multiply 3.375 times | Sixth time |

6. Examination of building models:

After the building models are assembled on the earthquake-stimulating vibration table, the judges have to examine the building model made by each group and record its mass. If the building model being tested does not conform to the making regulations of building models and the restricted net weight, it will be judged to multiply a penalty mass or nullify its testing qualification according to the extent of violation of the regulations.

In addition, if the design of the obliquely supporting structure of the building model is against the regulation, the building model will be punished to have its net weight multiplying two times.

7. Regulations of test:
(1). The building model must be designed in accordance with the regulations; otherwise its testing qualification will be nullified.
(2). Regulations for selecting wining teams in the vibration-resisting test are based on “efficiency ratio”, that is, the maximum acceleration that the building model bears under a fixed mass is divided by the material mass of the building model (including penalty mass). If the efficiency ratio of the building model is comparatively high, it indicates that the building model made of comparatively few materials can resist a comparatively huge earthquake and hence this building model will win the victory.
(3). If any of the following situations should happen, a penalty weight will be added to the material mass of the building model being tested after it is judged so by the judges:
   (a). A third person participates in the work of assembling the building model on the earthquake-simulating vibration table. (According to the regulation, only two persons are allowed to do such work):
   (b). In the testing process, if there is any irrelative person entering the restricted region, the judges will deduct scores or add penalty load to the building model:
   (c). During making of the building model, if non-prescribed materials or tools are used, the building model will be judged to lose its testing qualification:
   (d). When assembling the building model on the earthquake-simulating vibration table, if any participator takes advantage of opportunity to reinforce the structure of the building model and is dissuaded to no avail, penalty load will be added to the building model: and
   (e). If there is any improper behavior affecting the test and approved by a judging conference, the team will be punished by adding penalty weight to the building model or nullifying its testing qualification.

To sum up, this invention has the following advantages.

1. It is able to elevate students' interest in learning the vibration resistance principles of buildings and stir up their creativity and thinking ability in the methods of vibration resistance and reinforcement of buildings.

2. Cost of materials for making a building model is low so ordinary students can afford it.

3. It can be expanded to any schools to be a course of vibration resistance education.

While the preferred embodiment of the invention has been described above, it will be recognized and understood that various modifications may be made therein and the appended claims are intended to cover all such modifications that may fall within the spirit and scope of the invention.

What is claimed is:

1. A method for testing the vibration-resisting strength of building models comprising:
step 1: students to participate in model making divided into teams;
step 2: said team beginning to make said building model within six and a half hours, said building model necessary to be able to bear a weight of 1.2 kilograms;
step 3: said building model weighed with a scale after it is made, said building model assembled on an earthquake-simulating vibration table after it is weighed;
step 4: said building model beginning to be tested, each said team having 30 seconds to explain the design concept of said building model they made before said building model is tested;
step 5: said building models beginning to be tested, said earthquake-simulating vibration table able to produce simulated earthquakes, said simulated earthquakes containing various kinds of frequency of earthquakes, test of said building model beginning with a minimum seismic strength with 490 gal of acceleration, said seismic strength increasing by degrees until it reaches 1160 gal, said earthquake-simulating vibration table finally producing a maximum said seismic strength and making all said building models collapsed;
step 6: Registering the acceleration scores of said building model after finishing said test; and,
the method able to elevate students' interest in learning the vibration resistance principles of buildings and stir up students' creativity and thinking ability in methods of vibration resistance and reinforcement of buildings.

2. The method for testing the vibration-resisting strength of building models as claimed in claim 1, wherein said building model is made of Ivory board 540ₘₘ×387ₘₘ in size and has at least four floors respectively being 21_{cm} in length, 12_{cm} in width and 7_{cm} in height, said Ivory board having one edge formed with a gluing portion 1_{cm} in width, each floor of said building model formed with four sides, the front and the rear side of each floor necessary to be hollowed out, the intermediate portion of the left and the right side of each floor able to be cut out, the materials cut out of said left and right side of each floor used for reinforcing the structure of said floor, the height from the bottom to the ceiling of each said floor being at least 7_{cm}, each floor having its central portion formed with a solid space 5_{cm} in width, the ground floor of said building model formed with two assembling spaces at locations respectively distant from the front side and the rear side for 3_{cm} to 6_{cm}, said assembling spaces used for assembling said building model on a fundamental base, no other obliquely supporting members or reinforcing structure allowed to be assembled in said assembling spaces, the maximum net weight of each said building model being 124_{g}+5_{g}.

3. The method for testing the vibration-resisting strength of building models as claimed in claim 1, wherein a mass block is fixed on each floor of said building model by means of a magic felt and positioned at the mass center of each floor, each said mass block being 286_{g} in weight and 8_{cm}×5_{cm} in area.

4. The method for testing the vibration-resisting strength of building models as claimed in claim 1, wherein the calculation mode of giving scores is: (load of said mass block/net weight of said building model) x acceleration of collapse.

5. The method for testing the vibration-resisting strength of building models as claimed in claim 1, wherein after said building models are assembled on said earthquake-simulating vibration table, the judges have to examine each said building model and record its mass, said building model punished by adding penalty mass to its net weight if it is against the regulations of model making and surpasses a restricted net weight.

6. The method for testing the vibration-resisting strength of building models as claimed in claim 5, wherein a penalty coefficient is; weight of building model×(1+overweight(_{g})/10), said building model punished by doubling its net weight if its obliquely supporting structure or design does not conform to the regulations.

7. The method for testing the vibration-resisting strength of building models as claimed in claim 1, wherein the regulation of selecting winning teams in vibration resistance test is based on “efficiency ratio”, that is, maximum acceleration that said building model bears under fixed mass is divided by material mass (including penalty mass) of said building model, said building model with a comparatively great efficiency ratio indicating that said building model can employ comparatively few materials to resist a comparatively huge earthquake.

8. The method for testing the vibration-resisting strength of building models as claimed in claim 1, wherein if any of the following situations should happen and after it is judged, said building model would be punished by adding a penalty weight to its material mass:
(a). A third person participating in the work of assembling said building model on said earthquake-simulating vibration table (according to the regulation, only two persons allowed to do such work);
(b). The judges deducting scores or adding penalty weight to said building model if any irrelative person entering the restricted region during carrying out the test;
(c). The judges deciding to nullify the testing qualification of said building model if non-prescribed materials or tool are used for making said building model;
(d). During assembling of said building model, said team taking advantage of opportunity to reinforce the structure of said building model and dissuaded to no avail (adding penalty weight to said building model); and,
(e). Any improper behavior of any said team, which affects said test and is judged so, said building model punished by adding a penalty weight to its net weight or nullifying its qualification of test.

9. The method for testing the vibration-resisting strength of building models as claimed in claim 1, wherein if any of the following situations should happen in the process of vibration resistance test, any said team will be judged to lose the testing qualification:
(a). Unsteadiness and collapse happening to any floor of said building model;
(b). Any of aid mass blocks moving away from its fixed position;
(c). Any post of said building model moving away from the ground; and,
(d). Other portions of said building model judged to be damaged.
